(19) United States
(12) Patent Application Publication
(10) Pub. No.: US 2025/0095891 A1
(43) Pub. Date: Mar. 20, 2025

(54) COMPOSITION AND INJECTION MOLDED PRODUCT

(71) Applicant: TOKIN Corporation, Miyagi (JP)

(72) Inventor: Hidenori TAKAHASHI, Miyagi (JP)

(21) Appl. No.: 18/728,008

(22) PCT Filed: Dec. 20, 2022
(86) PCT No.: PCT/JP2022/046925

§ 371 Date: Jul. 10, 2024

(30) Foreign Application Priority Data
Jan. 24, 2022 (JP) 2022-008812

(51) Int. Cl. H01F 1/147; C08K 9/02; C08K 9/06; C08L 77/00

(52) U.S. Cl. CPC H01F 1/14766; C08K 9/02; C08K 9/06; C08L 77/00; C08K 2201/003; C08K 2201/01; C08K 2201/011

(57) ABSTRACT

A composition suitable for injection molding, from which a molded product excellent in magnetic properties may be obtained, and an injection molded product excellent in magnetic properties are provided. A composition includes a magnetic powder and a thermoplastic resin, at least a part of the magnetic powder having a coating layer.

### TECHNICAL FIELD

The present invention relates to a composition and an injection molded product.

### BACKGROUND ART

As magnetic cores for various magnetic elements such as choke coils and inductors, molded products of composition including a binder and a magnetic powder are known. As a method for producing the molded products, a pressure molding method with use of a thermosetting resin as a binder is widely known (for example, Patent Literature 1).

As magnetic powders excellent in magnetic properties, Fe-based nanocrystalline alloys having magnetic properties such as low coercive force, low magnetostriction, high magnetic permeability, and high saturation magnetic flux density are disclosed in Patent Literatures 2 to 4.

On the other hand, in Patent Literature 5, a method for injection molding a composition including a thermoplastic resin and a magnetic powder is disclosed.

### CITATION LIST

### Patent Literature

Patent Literature 1: Japanese Unexamined Patent Application Publication No. 2010-10426
Patent Literature 2: Japanese Unexamined Patent Application Publication No. 2012-12699
Patent Literature 3: Japanese Unexamined Patent Application Publication No. 2010-150665
Patent Literature 4: International Patent Publication No. WO 2011/24580
Patent Literature 5: Japanese Unexamined Patent Application Publication No. 2019-102713

### SUMMARY OF INVENTION

### Technical Problem

For example, in the case of using the magnetic powder of Fe-based nanocrystalline alloy to produce a molded product by pressure molding, the core loss (iron loss) may be larger than designed in some cases. As a result of extensive studies, the present inventor has found that distortion occurs in the magnetic powder during pressure molding in some cases.

In order to solve the problem, an object of the present invention is to provide a composition suitable for injection molding and from which a molded product excellent in magnetic properties can be obtained, and an injection molded product excellent in magnetic properties.

### Solution to Problem

The composition of the present invention includes a magnetic powder and a thermoplastic resin, and at least a part of the magnetic powder has a coating layer.

In the composition, the coating layer may include one or more selected from a glass, a silicone resin, and a coupling agent.

In the composition, the coating layer may include one or more selected from a glass and a silicone resin.

In the composition, the coating layer may include a coupling agent.

In the composition, the coating layer may have a first layer including one or more selected from a glass and a silicone resin, and a second layer including a coupling agent.

In the composition, the magnetic powder may include an Fe-based nanocrystalline alloy.

In the composition, the magnetic powder may include an Fe—Si alloy.

In the composition, the magnetic powder may include a first magnetic powder having a median diameter of 1 to 50 μm and a second magnetic powder having a median diameter of 10 to 300 μm, and the median diameter of the second magnetic powder may be larger than the median diameter of the first magnetic powder.

In the composition, the first magnetic powder may be an Fe-based nanocrystalline alloy, and the second magnetic powder may be an Fe—Si alloy.

The composition may have a mass ratio between the first magnetic powder and the second magnetic powder of 95:5 to 50:50.

In the composition, the glass may include a phosphate glass.

The composition may have a melt flow rate of 80 g/10 minutes or more at 330° C.

The composition may be used for injection molding.

An injection molded product of the present invention is an injection molded product of the composition of the present invention.

The injection molded product may have a core loss of 350 kW/m³ or less measured under conditions at a frequency of 20 kHz and an applied magnetic flux density of 100 mT.

The injection molded product may have a core loss of 2800 kW/m³ or less measured under conditions at a frequency of 100 kHz and an applied magnetic flux density of 100 mT.

The injection molded product may have a magnetic permeability retention rate of 83% or more at a frequency of 100 kHz and a magnetic field strength of 8 kA/m.

The injection molded product may have a radial crushing strength of 40 MPa or more.

The injection molded product may have a resistance value of 1×10¹³Ω or more.

### Advantageous Effects of Invention

The present invention provides a composition suitable for injection molding, from which a molded product excellent in magnetic properties can be obtained, and an injection molded product excellent in magnetic properties.

### BRIEF DESCRIPTION OF DRAWINGS

FIG. 1 is a schematic cross-sectional view showing an example of magnetic powder having a coating layer.

FIG. 2 is another schematic cross-sectional view showing an example of magnetic powder having a coating layer.

FIG. 3 is a schematic cross-sectional view showing an example of an injection molded product.

FIG. 4 is a schematic cross-sectional SEM image of an injection molded product in Example 1.

FIG. 5 is a schematic cross-sectional SEM image of an injection molded product in Example 1.

### DESCRIPTION OF EMBODIMENTS

Hereinafter, the present invention will be described through embodiments of the invention, though the invention according to Claims is not limited to the following embodiments.

For clarity of explanation, the following descriptions and drawings are appropriately simplified. For illustrative purposes, the scale of each element in the drawings may differ significantly.

In addition, unless otherwise specified, a term “to” indicating a numerical range includes the lower limit and the upper limit.

### [Composition]

The composition according to the present invention includes a magnetic powder and a thermoplastic resin, and at least a part of the magnetic powder has a coating layer.

With use of the magnetic powder having a coating layer, the present composition has an improved fluidity as composition when the thermoplastic resin is heated to the melting point or more. Accordingly, the composition is suitable for injection molding. Since a molded product can be formed by injection molding, a distortion problem of the magnetic powder that may occur during pressure molding does not occur, so that a molded product excellent in magnetic properties can be obtained. Further, with use of the magnetic powder having a coating layer, the adhesion between the magnetic powder and a thermoplastic resin is improved, so that an effect of improving the mechanical strength such as radial crushing strength of a molded product can be also obtained.

The composition includes at least a magnetic powder having a coating layer and a thermoplastic resin, and may further include other components within the range in which the effect of the present invention is exhibited. Each component will be described below.

### <Magnetic Powder>

The magnetic powder may be appropriately selected from known magnetic powders used in cores for magnetic elements according to the required magnetic properties. From the viewpoint of magnetic properties, a soft magnetic powder such as a soft magnetic powder containing iron (Fe) as main component (50 at % or more) is preferred.

The composition of magnetic powder may be iron alone or an alloy including iron and other elements. Examples of the other elements include boron (B), nitrogen (N), carbon (C), oxygen (O), phosphorus (P), silicon (Si), nickel (Ni), chromium (Cr), aluminum (Al), copper (Cu), titanium (Ti), zirconium (Zr), hafnium (Hf), niobium (Nb), tantalum (Ta), molybdenum (Mo), tungsten (W), chromium (Cr), cobalt (Co), manganese (Mn), silver (Ag), zinc (Zn), tin (Sn), arsenic (As), antimony (Sb), bismuth (Bi), yttrium (Y), and rare earth elements such as samarium (Sm).

Specific examples of the soft magnetic powders include carbonyl iron, Fe—Si alloys, Fe—Ni alloys, Fe—Si—Cr alloys, Fe—Si—Al alloys, Fe-based amorphous alloy powders including at least Fe—B, and Fe-based nanocrystalline alloys including at least Fe—B—P—Cu. Here, the Fe-based amorphous alloys refer to amorphous Fe-based alloys having no crystal structure. Further, the Fe-based nanocrystalline alloys refer to alloys obtained by heat-treating the Fe-based amorphous alloys to precipitate fine α-Fe crystals in the amorphous phase. The magnetic powder may be used alone or in combination of two or more.

In the present composition, the magnetic powder preferably includes an Fe-based nanocrystalline alloy and/or an Fe—Si alloy, more preferably an Fe-based nanocrystalline alloy. In the Fe-based nanocrystalline alloy, a highly magnetized α-Fe phase is present as fine nanocrystals to reduce magnetocrystalline anisotropy, and a mixed phase including the amorphous phase having a positive magnetostriction and the α-Fe phase having a negative magnetostriction reduces the magnetostriction, so that good magnetic properties with a high saturation magnetic flux density (Bs) and a low loss can be obtained.

### (Fe-Based Nanocrystalline Alloy)

It is preferable that the Fe-based nanocrystalline alloy include at least Fe, B, P, and Cu. From the viewpoints of magnetic properties and ease of production, it is preferable that the Fe-based nanocrystalline alloy have a composition that satisfies the following formula (1) or (2), in particular. Incidentally, B, P, Si, and C are elements that contribute to amorphous phase formation, and Cu is an element that contributes to nanocrystallization.

$${Fe}_{w} {B}_{x} {P}_{y} {Cu}_{z} \qquad ( 1 )$$

$${Fe}_{a} {B}_{b} {Si}_{c} {P}_{d} {C}_{e} {Cu}_{f} \qquad ( 2 )$$

where, in formula (1), w is 76 to 88 at %, x is 4 to 13 at %, y is 1 to 10 at %, z is 0.5 to 1.5 at %, and w+x+y+z is 100 at %, and
in formula (2), a is 76 to 88 at %, b is 4 to 13 at %, c is 0 to 8 at %, d is 0.1 to 10, e is 0 to 5 at %, f is 0.4 to 1.4 at %, and a+b+c+d+e+f is 100 at %.

In common with the formulas (1) and (2), other elements such as Ti, Zr, Hf, Nb, Ta, Mo, W, Cr, Co, Ni, Al, Mn, Ag, Zn, Sn, As, Sb, Bi, Y, N, O, S, and rare earth elements may be contained at 3 at % or less relative to the entire composition. In this case, w in formula (1) and a in formula (2) represent the content rates of the total of iron and the other elements.

It is preferable that the shape of the Fe-based nanocrystalline alloy be spherical from the viewpoints of magnetic properties, injection moldability, and ease of production of an alloy. In the present embodiment, the spherical shape means that the aspect ratio of the alloy observed from a cross-sectional SEM (scanning electron microscope) image of the injection molded product is 1 to 3, preferably 1 to 2.

Further, it is preferable that the median diameter (D50) of the Fe-based nanocrystalline alloy be 1 to 50 μm from the viewpoints of magnetic properties, injection moldability, and ease of production of an alloy. Incidentally, in the present embodiment, the median diameter is a value calculated from a particle size distribution measured by laser diffraction method.

The Fe-based nanocrystalline alloy may be produced with reference to, for example, Japanese Unexamined Patent Application Publication No. 2012-12699, Japanese Unexamined Patent Application Publication No. 2010-150665, and International Patent Publication No. WO 2011/24580. Specifically, the production may be performed by preparing an alloy composition that satisfies the formula (1) or (2) and has an amorphous phase as main phase, powdering the composition by an atomizing method or the like, and heat-treating the powder at a predetermined temperature. According to the method described above, spherical particles with a median diameter of 1 to 50 μm may be obtained.

### (Fe—Si Alloy)

As the magnetic powder, it is preferable that the Fe—Si alloy is used alone or in combination with the Fe-based nanocrystalline alloy. With use of the Fe—Si alloy, an injection molded product having a relatively high magnetic permeability and a low loss may be obtained.

The rate of Si in the Fe—Si alloy is preferably 2 to 10 mass %, more preferably 3 to 7 mass %, relative to the total amount of the Fe—Si alloy.

The Fe—Si alloy may further include other elements such as Cr, Al, Mn, Ni, C, O, N, S, P, B and Cu. The content of the other elements is preferably 3 mass % or less, more preferably 1 mass % or less, relative to the total amount of the Fe—Si alloy.

It is preferable that the shape of the Fe—Si alloy be spherical from the viewpoints of magnetic properties and injection moldability.

Further, it is preferable that the median diameter (D50) of the Fe—Si alloy be 1 to 500 μm from the viewpoints of magnetic properties and injection moldability.

The Fe—Si alloy may be obtained by preparing the composition described above and powdering the same by an atomizing method or the like. A commercial product having a desired composition and a particle size may also be used.

In the present embodiment, the magnetic powder for use may be a combination of a first magnetic powder having a median diameter of 1 to 50 μm and a second magnetic powder having a median diameter of 10 to 300 μm, preferably 60 to 300 μm. By combining the second magnetic powder having a larger median diameter than the first magnetic powder, a composition excellent in fluidity and injection moldability may be obtained even in the case of having a high ratio of magnetic powder. In the case where the first magnetic powder and the second magnetic powder are combined, the ratio of the magnetic powder in the composition may be 70 to 85 vol %, preferably 70 to 80 vol %.

Furthermore, it is preferable that the ratio between the median diameter d50₂ of the second magnetic powder and the median diameter d50₁ of the first magnetic powder (d50₂/d50₁) be 1.5 or more. With a d50₂/d50₁ of 1.5 or more, the composition tends to have more improved fluidity.

In this case, the first magnetic powder is preferably an Fe-based nanocrystalline alloy, and the second magnetic powder is preferably an Fe—Si alloy, for ease of production.

The mass ratio between the first magnetic powder and the second magnetic powder is preferably 95:5 to 50:50, more preferably 80:20 to 70:30, from the viewpoints of magnetic properties and fluidity.

On the other hand, in the case where the ratio of the magnetic powder in the composition is less than 70 vol %, it is preferable that the Fe-based nanocrystalline alloy be used alone from the viewpoint of magnetic properties.

In the case of using the Fe-based nanocrystalline alloy alone, the ratio of the magnetic powder in the composition is preferably 60 to 70 vol %, more preferably 62 to 68 vol %, relative to 100 vol % of the present composition, from the viewpoint of achieving both injection moldability and magnetic properties.

### <Coating Layer>

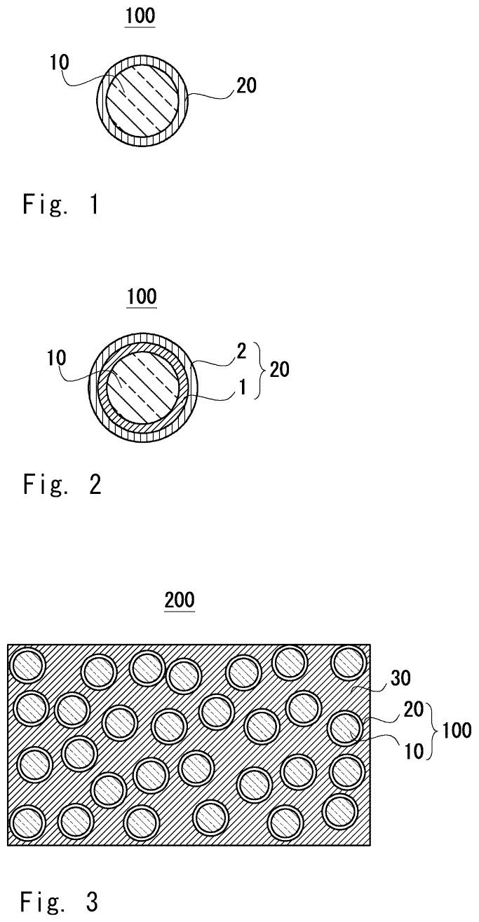

In the present embodiment, at least a part of the magnetic powder has a coating layer. FIG. 1 and FIG. 2 are schematic cross-sectional views showing an example of magnetic powder 100 having a coating layer. A coating layer 20 is formed on the surface of a magnetic powder 10 as in the examples in FIG. 1 and FIG. 2. The coating layer 20 may be a single layer as in the example in FIG. 1, or the coating layer 20 may have a laminated structure of two or more layers having a first layer 1 and a second layer 2 as in FIG. 2. Also, the coating layer 20 may be a single layer including two or more components. Further, the coating layer 20 may cover the entire surface of the magnetic powder, or may have an intermittent portion.

It is preferable that the material of the coating layer is selected from those having at least one or more functions including improving fluidity, improving insulating properties, and improving adhesion to a thermoplastic resin.

Specific examples thereof include a glass, a silicon resin, and a coupling agent.

From the viewpoint of insulating properties, it is preferable that the coating layer include a glass or a silicon resin. Through provision of the coating layer including a glass or a silicone resin, direct contact between magnetic particles is suppressed, so that the insulating properties are improved.

Examples of the glass include a silicate glass, a borate glass, a borosilicate glass, and a phosphate glass. Among them, a phosphate glass is preferred. Through provision of a coating layer including a phosphate glass, the fluidity of the composition is improved. Incidentally, the phosphate glass may include other inorganic oxides such as ZnO, SiO₂, Bi₂O₃ and Al₂O₃.

The coating amount of the glass and the silicone resin is preferably 0.3 to 5 vol %, more preferably 0.5 to 3 vol %, relative to 100 vol % of the present composition.

From the viewpoints of improving the adhesion to the thermoplastic resin and improving the mechanical strength of the injection molded product, it is preferable that the coating layer contain a coupling agent. Examples of the coupling agent include a silane coupling agent, a titanium coupling agent and a zirconium coupling agent, and a silane coupling agent is preferred. The organic group that the silane coupling agent has may be appropriately selected corresponding to the type of thermoplastic resin, in consideration of affinity. Specific examples of the silane coupling agent include methyltrimethoxysilane, dimethyldimethoxysilane, phenyltrimethoxysilane, dimethoxydiphenylsilane, trifluoropropyl trimethoxysilane, n-propyltriethoxysilane, vinyltrimethoxysilane, 3-glycidoxypropylmethyldimethoxysilane, p-styryltrimethoxysilane, 3-methacryloxypropylmethyldimethoxysilane, 3-acryloxypropyltrimethoxysilane, N-2-(aminoethyl)-3-aminopropylmethyldimethoxysilane, N-2-(aminoethyl)-3-aminopropyltrimethoxysilane, 3-aminopropyltrimethoxysilane, 3-aminopropyltriethoxysilane, 3-ureidopropyltrialkoxysilane, 3-isocyanatopropyltriethoxysilane, tris-(trimethoxysilylpropyl)isocyanurate, and 3-mercaptopropylmethyldimethoxysilane, which may be used alone or in combination of two or more.

The coating amount of the coupling agent is preferably 0.3 to 3 vol %, more preferably 0.5 to 2 vol %, and still more preferably 0.6 to 1.2 vol %, relative to 100 vol % of the present composition.

From the viewpoints of fluidity, insulating properties, and improved adhesion to a thermoplastic resin, it is preferable that the coating layer have a laminated structure having a first layer including one or more selected from a glass and a silicone resin and a second layer including a coupling agent, and it is more preferable that the first layer include glass. In this case, as in the example shown in FIG. 2, the layer structure includes the magnetic powder 10, the first layer 1, and the second layer 2. The coupling agent in the second layer has excellent adhesion to the glass or silicon resin in the first layer and excellent affinity with a thermoplastic resin, so that the adhesion between the magnetic powder and thermoplastic resin is improved, resulting in improved mechanical strength of an injection molded product.

The method of forming the coating layer may be appropriately selected according to the type of coating material. In the case of a glass agent, a glass layer may be formed on the surface of magnetic powder by a thin film forming method such as sol-gel method, or by a method of mixing magnetic powder and glass powder under mechanical stress. In the case of a silicone resin or a coupling agent, a solution or dispersion containing the coating material may be prepared and applied by various coating methods or dipping methods.

### <Thermoplastic Resin>

The thermoplastic resin may be appropriately selected depending on the injection moldability, the heat resistance and mechanical strength required for an injection molded product. Specific examples of the thermoplastic resin include polyvinyl chloride, polystyrene, acrylonitrile-butadiene-styrene (ABS) resins, polyamides including aromatic polyamide, polyethylene, polypropylene, methacrylic resins, polycarbonate, polyimide, polyamideimide, polyether ether ketone, and polyphenylene sulfide, which may be used alone or in combination of two or more.

In the present embodiment, the thermoplastic resin preferably includes polyamide, polyphenylene sulfide, or polyether ether ketone, more preferably polyamide, from the viewpoints of mechanical strength and the like.

The ratio of the thermoplastic resin in the composition is preferably 20 to 40 vol %, more preferably 25 to 35 vol %, and still more preferably 30 to 35 vol %, relative to 100 vol % of the present composition, from the viewpoints of achieving both injection moldability and magnetic properties.

### <Optional Component>

The present composition may further include other components within the range in which the effect of the present invention is exhibited. Examples of the other components include function-imparting agents such as antioxidants, lubricants, ultraviolet absorbers, metal deactivators, HALS, stabilizers such as stabilizers for PVC, plasticizers, flame retardants, nucleating agents, fillers, compatibilizers, curing agents, photoinitiators, antistatic agents, anti-fogging agents, conductive agents, clarifying agents, lubricants, and antibacterial agents, which may be used alone or in combination of two or more.

From the viewpoint of injection moldability, the present composition preferably has a melt flow rate at 330° C. of 80 g/10 minutes or more, more preferably 90 g/10 minutes or more. The melt flow rate is a value measured according to JIS K 7210, using a melt indexer, with a die (nozzle) having an inner diameter of 1.05 mm and a length of 4 mm under conditions at a measurement temperature of 330° C. and a test pressure of 20 kg.

The melt flow rate of the present composition may be adjusted according to the type and content rate of the thermoplastic resin, the particle size and content rate of the magnetic powder, and the like.

The method for producing the present composition is not particularly limited, and for example, the composition may be obtained by adding a magnetic powder having a coating layer and each component used as necessary to a heated thermoplastic resin and kneading the mixture.

Due to combination of the magnetic powder having a coating layer and the thermoplastic resin, the present composition has excellent injection moldability and is suitable as an injection molding composition for forming a core of various magnetic elements.

### [Injection Molded Product]

The injection molded product of the present invention is a molded product obtained by injection molding of the composition. FIG. 3 is a schematic cross-sectional view showing an example of the injection molded product. As shown in the example in FIG. 3, injection molded product 200 is molded in a state with magnetic powder 100 having a coating layer dispersed in thermoplastic resin 30. The injection molded product is molded without application of pressure, having excellent magnetic properties without a problem of distortion of the magnetic powder that may occur during pressure molding.

Since each component that may be included in the present injection molded product, the content rate thereof and the like are the same as those of the composition described above, description thereof is omitted here.

The injection molding method is not particularly limited. For example, an injection molded product may be obtained by filling the cavity of a mold with a composition of molten thermoplastic resin using a cylinder and cooling the composition. Alternatively, with reference to Japanese Unexamined Patent Application Publication No. 2019-102713, etc., a molded product in which a coil is embedded may be formed.

The present injection molded product may be a low-loss core. For example, the injection molded product is capable of having a core loss of 350 kW/m³ or less, preferably 310 kW/m³ or less, more preferably 300 kW/m³ or less, measured under conditions at a frequency of 20 kHz and an applied magnetic flux density of 100 mT.

Further, for example, the injection molded product is capable of having a core loss of 2800 kW/m³ or less, preferably 2700 kW/m³ or less, more preferably 2400 kW/m³ or less, measured under conditions at a frequency of 100 kHz and an applied magnetic flux density of 100 mT.

The present injection molded product is excellent in DC superimposition characteristics. For example, the present injection molded product is capable of having a magnetic permeability retention rate of 83% or more, preferably 83.5% or more, more preferably 85% or more at a frequency of 100 kHz and a magnetic field strength of 8 kA/m. Note that the magnetic permeability retention rate is a value calculated from magnetic permeability measured under conditions at a magnetic field strength of 0 and magnetic permeability μ′ measured under the conditions described above based on the following formula (3).

$$Retention rate ( \% ) = ( {μ}^{′} / μ ) \times 100 \qquad ( 3 )$$

The present injection molded product is excellent in adhesion between the magnetic powder and the thermoplastic resin, and has high mechanical strength. For example, the injection molded product is capable of having a radial crushing strength of 35 MPa or more, preferably 40 MPa or more, and more preferably 42 MPa or more. In the present embodiment, the radial crushing strength is a value obtained according to the test method for radial crushing strength in JIS Z2507.

Further, the injection molded product is excellent in insulating properties. For example, the present injection molded product is capable of having a resistance value of 1×10¹³Ω or more.

The injection molded product having the properties described above may be suitably used for any conventionally known applications, and may be suitably used, for example, as a magnetic core for various magnetic elements such as choke coils and inductors.

### EXAMPLES

The present invention will be specifically described as follows with reference to Examples and Comparative Examples. However, these descriptions do not limit the present invention.

### Example 1

As magnetic powders, the following Fe-based nanocrystalline alloy A and Fe—Si alloy (Si content: 6.5 mass %, D50: 150 μm) were prepared, and each was coated with a phosphate glass at 1.9 vol % relative to 100 vol % of the following composition, so that a coating layer 1 was formed. Next, a coating layer 2 was formed with 3-aminopropyltriethoxysilane (silane coupling agent; KBE-903 manufactured by Shin-Etsu Chemical Co., Ltd.) at 0.6 vol % relative to 100 vol % of the following composition, so that a magnetic powder having coating layers was obtained.

Next, to a molten aromatic polyamide (thermoplastic resin; PA9T (N1000A) manufactured by Kuraray Co., Ltd.), the Fe-based nanocrystalline alloy and the Fe—Si alloy were added at a mass ratio of 8:2 to obtain a composition with a magnetic powder rate of 70 vol %.

The composition was injection molded using an injection molding machine (STX-10S2V) manufactured by Nissei Plastic Industrial Co., Ltd. to obtain a ring-shaped molded product having an outer diameter of 13 mm and an inner diameter of 8 mm.

### Examples 2 to 14

A molded product having the shape described above was obtained in the same manner as in Example 1, except that the composition was changed as shown in Tables 1 to 3. In the tables, coating layer 1 or coating layer 2 described as “-” indicates that coating layer 1 or coating layer 2 is not provided and the coating layer is a single layer.

### Comparative Example 1

A molded product having the shape described above was obtained in the same manner as in Example 1, except that the composition was changed as shown in Tables 1.

### Comparative Example 2

The composition was changed as shown in Table 3, and pressure molding was performed at a molding pressure of 5 ton/cm² instead of injection molding, so that a molded product having the same shape as in Example 1 was obtained. Incidentally, the phenolic resin is a thermosetting resin.

Regarding the composition, abbreviations in the table are as follows.
Alloy A: Fe-based nanocrystalline alloy A (Fe_{84.3}B₆P₉Cu_{0.7} (at %), D50: 30 μm)
Alloy B: Fe-based nanocrystalline alloy B (Fe_{84.3}B₉P₆Cu_{0.7} (at %), D50: 30 μm)
Fe-6.5Si: Fe—Si alloy (Si content: 6.5 mass %, D50: 150 μm)
KBE-903: 3-aminopropyltriethoxysilane

### [Evaluation]

### <Melt Flow Rate MFR>

Using a melt indexer (Melt Indexer (Type C 50590) manufactured by Toyo Seiki Seisaku-sho, Ltd.), the melt flow rate of the composition before molding was measured with a die (nozzle) having an inner diameter of 1.05 mm and a length of 4 mm under conditions at a measurement temperature of 330° C. and a test pressure of 20 kg in accordance with JIS K 7210.

### <Density>

As the density of a molded product, the apparent density was calculated from the volume and weight of the molded product.

### <Radial Crushing Strength>

The compression test of a molded product was performed using a small tabletop tester (LITTLE SENSTARLS C-02/300-2) manufactured by Tokyo Testing Machine Co., Ltd. The measurement according to the test method for radial crushing strength of JIS Z2507 was performed to calculate and evaluate the radial crushing strength from Formula (4).

$$K = [ F \times D - e ) ] / ( L \times {e}^{2} ) : \qquad Formula ( 4 )$$

K: Radial crushing strength (MPa)
F: Maximum load when destroyed (N)
L: Length of hollow cylinder (mm)
D: Outer diameter of hollow cylinder (mm)
e: Wall thickness of hollow cylinder (mm)

### <Insulation Resistance>

The insulation resistance of a molded product was measured by applying a voltage of 100 V between electrodes having a diameter of 1 mm on the top and bottom of the molded product, using an ohmmeter (B2985A) manufactured by Keysight Technologies.

### <Saturation Magnetization Js>

Calculation was performed from a B—H curve obtained using a BH analyzer (BH5501) manufactured by Denshijiki Industry Co., Ltd.

### <Magnetic Permeability μ, μ′, and Retention Rate Δμ>

For the measurement of magnetic permeability, a copper wire was wound with 10 turns on a ring-shaped molded product having an outer diameter of 13 mm and an inner diameter of 8 mm. The measurement of the magnetic permeability μ or μ′ was performed using an LCR meter (4284A) manufactured by HP, under conditions at a frequency of 100 kHz and a magnetic field strength of 0 or 8 kA/m, and the retention rate Δμ was obtained based on the formula (3).

### <Core Loss Pcv>

The core loss was measured using a BH analyzer (SY8219) manufactured by Iwatsu Electric Co., Ltd., under the following two conditions. Pcv1 and Pcv2 are described in order.
(1) Frequency: 20 kHz, applied magnetic flux density: 100 mT
(2) Frequency: 100 kHz, applied magnetic flux density: 100 mT

The evaluation results are shown in Tables 1 to 3.

TABLE 1

| | | | | | | Comparative |
|---|---|---|---|---|---|---|
| | | Example 1 | Example 2 | Example 3 | Example 4 | Example 1 |
| Composition | Thermoplastic resin | Aromatic | Aromatic | Aromatic | Aromatic | Aromatic |
| | | polyamide | polyamide | polyamide | polyamide | polyamide |
| | Magnetic powder | Alloy A/Fe—6.5Si | Alloy A/Fe—6.5Si | Alloy A/Fe—6.5Si | Alloy A/Fe—6.5Si | Alloy A/Fe—6.5Si |
| | (mass ratio) | 8/2 | 8/2 | 8/2 | 8/2 | 8/2 |
| | Coating layer 1 | Phosphate glass [symbol] | Phosphate glass [symbol] | Phosphate glass [symbol] | — | — |
| | (coating amount) | [symbol] vol % | [symbol] vol % | [symbol] vol % | | |
| | Coating layer 2 | KBE903 | KBE903 | — | KBE903 | — |
| | (coating amount) | [symbol] vol % | 0.6 vol % | | 0.6 vol % | |
| | Ratio of magnet powder | 70 vol % | 70 vol % | 70 vol % | 70 vol % | 70 vol % |
| | (vol %) | | | | | |
| Evaluation | Density (g/cc) | 5.55 | 5.53 | 5.53 | 5.49 | 5.48 |
| | MFR (g/10 min) | 395.1 | 370.0 | 404.6 | 96.4 | 87.1 |
| | Radial crushing strength | 55.4 | 50.4 | 42.6 | 62.0 | 56.4 |
| | (Mpa) | | | | | |
| | Insulation resistance (Ω) | 2.90 × 10 [symbol] | 1.20 × 10 [symbol] | 2.30 × 10 [symbol] | 6.00 × 10 [symbol] | 5.90 × 10 [symbol] |
| | Js (T) | [symbol] | [symbol] | [symbol] | [symbol] | [symbol] |
| | μ | [symbol] | [symbol] | [symbol] | [symbol] | [symbol] |
| | Δμ (%) | 93.4 | 89.9 | 91.7 | 83.7 | 83.2 |
| | Pcv 1 (kW/m [symbol] ) | 256.6 | 252.4 | 236.8 | 286.8 | 313.3 |
| | Pcv 2 (kW/m [symbol] ) | 2114 | 2187 | 1985 | 2362 | 2434 |

[symbol]

indicates data missing or illegible when filed

TABLE 2

| | | Example 5 | Example 6 | Example 8 | Example 9 |
|---|---|---|---|---|---|
| Composition | Thermoplastic | Aromatic | Aromatic | Aromatic | Aromatic |
| | resin | polyamide | polyamide | polyamide | polyamide |
| | Magnetic powder | Alloy A/Fe—6.5Si | Alloy B/Fe—6.5Si | Alloy A/Fe—6.5Si | Alloy A/Fe—6.5Si |
| | (mass ratio) | 8/2 | 8/2 | 8/2 | 8/2 |
| | Coating layer 1 | Silicone resin: | Bi-based glass: | Phosphate glass: | Phosphate glass: |
| | (coating amount) | 1.1 vol % | 1.9 vol % | 1.9 vol % | 1.9 vol % |
| | Coating layer 2 | KBE903 | KBE903 | KBE903 | KBE903 |
| | (coating amount) | 0.6 vol % | 0.6 vol % | 1.2 vol % | 1.8 vol % |
| | Ratio of magnet | 70 vol % | 70 vol % | 70 vol % | 70 vol % |
| | powder (vol %) | | | | |
| Evaluation | Density (g/cc) | 5.50 | 5.61 | 5.54 | 5.52 |
| | MFR (g/10 min) | 95.3 | 97.0 | 354.7 | 186.6 |
| | Radial crushing | 58.2 | 52.1 | 46.5 | 62.0 |
| | strength (Mpa) | | | | |
| | Insulation | 8.40 × 10¹³ | 9.60 × 10⁴ | 1.60 × 10¹⁴ | 5.70 × 10¹⁴ |
| | resistance (Ω) | | | | |
| | Js (T) | 1.12 | 1.14 | 1.13 | 1.10 |
| | μ | 18.9 | 20.5 | 19.7 | 19.4 |
| | Δμ (%) | 94.5 | 95.3 | 94.2 | 94.8 |
| | Pcv 1 (kW/m³) | 266.7 | 302.3 | 224.1 | 235.3 |
| | Pcv 2 (kW/m³) | 2257 | 2453 | 1986 | 2062 |

TABLE 3

| | | Example 10 | Example 11 | Example 12 | Example 13 |
|---|---|---|---|---|---|
| Composition | Thermoplastic resin | Aromatic polyamide | Aromatic polyamide | Aromatic polyamide | Aromatic polyamide |
| | Magnetic powder | Alloy B | Alloy B | Alloy B/Fe—6.5Si | Alloy B/Fe—6.5Si |
| | (mass ratio) | | | [symbol] | [symbol] |
| | Coating layer 1 | Phosphate glass [symbol] | Phosphate glass [symbol] | Phosphate glass [symbol] | Phosphate glass [symbol] |
| | (coating amount) | [symbol] vol % | [symbol] vol % | [symbol] vol % | [symbol] vol % |
| | Coating layer 2 | KBE903 | KBE903 | KBE903 | KBE903 |
| | (coating amount) | [symbol] vol % | [symbol] vol % | [symbol] vol % | [symbol] vol % |
| | Ratio of magnet powder | [symbol] vol % | [symbol] vol % | [symbol] vol % | [symbol] vol % |
| | (vol %) | | | | |
| Evaluation | Density (g/cc) | [symbol] | [symbol] | [symbol] | [symbol] |
| | MFR (g/10 min) | [symbol] | [symbol] | [symbol] | [symbol] |
| | Radial [symbol] strength | [symbol] | [symbol] | [symbol] | [symbol] |
| | (Mpa) | | | | |
| | Insulation resistance (Ω) | [symbol] × 10 [symbol] | [symbol] × 10 [symbol] | [symbol] × 10 [symbol] | [symbol] × 10 [symbol] |
| | Js (T) | [symbol] | [symbol] | [symbol] | [symbol] |
| | μ | [symbol] | [symbol] | [symbol] | [symbol] |
| | Δμ (%) | [symbol] | [symbol] | [symbol] | [symbol] |
| | P [symbol] v 1 (kW/m [symbol] ) | [symbol] | [symbol] | [symbol] | [symbol] |
| | P [symbol] v 2 (kW/m [symbol] ) | [symbol] | [symbol] | [symbol] | [symbol] |

| | | Example 14 | Example 15 | Comparative |
|---|---|---|---|---|
| Composition | Thermoplastic resin | Aromatic polyamide | Aromatic polyamide | Phenol resin |
| | Magnetic powder | Alloy B/Fe— [symbol] Si | Alloy B/Fe— [symbol] Si | Alloy A/Fe— [symbol] Si |
| | (mass ratio) | [symbol] | [symbol] | [symbol] |
| | Coating layer 1 | Phosphate glass [symbol] | Phosphate glass [symbol] | Phosphate glass [symbol] |
| | (coating amount) | [symbol] vol % | [symbol] vol % | [symbol] vol % |
| | Coating layer 2 | KBE903 | KBE903 | KBE903 |
| | (coating amount) | [symbol] vol % | [symbol] vol % | [symbol] vol % |
| | Ratio of magnet powder | [symbol] vol % | [symbol] vol % | [symbol] vol % |
| | (vol %) | | | |
| Evaluation | Density (g/cc) | [symbol] | [symbol] | [symbol] |
| | MFR (g/10 min) | [symbol] | [symbol] | — |
| | Radial [symbol] strength | [symbol] | [symbol] | [symbol] |
| | (Mpa) | | | |
| | Insulation resistance (Ω) | [symbol] × 10 [symbol] | [symbol] × 10 [symbol] | [symbol] × 10 [symbol] |
| | Js (T) | [symbol] | [symbol] | [symbol] |
| | μ | [symbol] | [symbol] | [symbol] |
| | Δμ (%) | [symbol] | [symbol] | [symbol] |
| | P [symbol] v 1 (kW/m [symbol] ) | [symbol] | [symbol] | [symbol] |
| | P [symbol] v 2 (kW/m [symbol] ) | [symbol] | [symbol] | [symbol] |

[symbol]

indicates data missing or illegible when filed

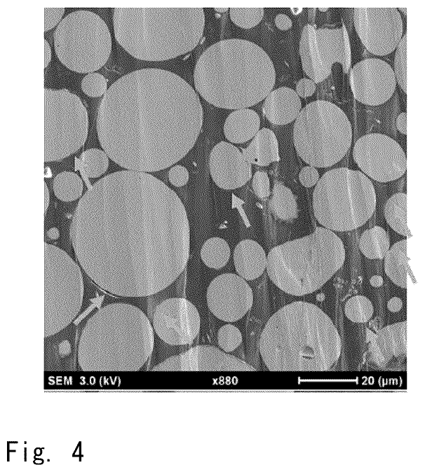

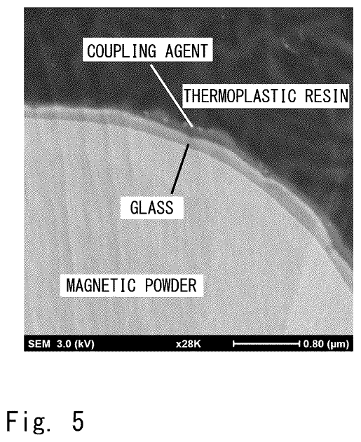

Moreover, the molded product in Example 1 was cut, and the cut surface was observed by SEM. The SEM images are shown in FIGS. 4 and 5. As shown in FIG. 5, the molded product in Example 1 is excellent in wettability of the thermoplastic resin to the coating layer, so that the coating layer and the thermoplastic resin are in close contact with each other. As shown in FIG. 4, although a slight gap is observed between the magnetic powder and the thermoplastic resin of the molded product in Example 1, it is presumed that the magnetic powder and the thermoplastic resin are in close contact with each other as a whole, so that the strength is improved.

The composition and molded product in Comparative Example 1 using magnetic powder having no coating layer were inferior to those in Examples in terms of the melt flow rate, insulation resistance, DC superimposition characteristics and core loss.

In Comparative Example 2, in which pressure molding using a thermosetting resin was performed, it was shown that even by using the same magnetic powder as in Example 1, the core loss was large, in particular. It is presumed that this was caused by distortion of the magnetic powder during pressure molding.

It is shown that the molded product in Example 4 with use of the magnetic powder having a coating layer of silane coupling agent was superior to that in Comparative Example 1 particularly in terms of radial crushing strength and suppression of core loss.

In addition, it is shown that the molded product in Example 3 with use of the magnetic powder having a phosphate glass coating layer particularly had an improved melt flow rate compared to that in Comparative Example 1, and was superior in terms of core loss suppression.

It is shown that the molded products in Examples 1 to 2 and Examples 5 to 15, which were injection molded from a composition including magnetic powder having two coating layers and a thermoplastic resin, have excellent performance in terms of radial crushing strength, insulation resistance, DC superimposition characteristics, and core loss.

Thus, the injection molded product of the present embodiment may be suitably used as a magnetic core for various magnetic elements such as choke coils and inductors.

The application claims priority based on Japanese Patent Application No. 2022-8812 filed on Jan. 24, 2022, and the entire disclosure thereof is incorporated herein.

### REFERENCE SIGNS LIST

1 FIRST LAYER (COATING LAYER)
2 SECOND LAYER (COATING LAYER)
10 MAGNETIC POWDER
20 COATING LAYER
30 THERMOPLASTIC RESIN
100 MAGNETIC POWDER HAVING COATING LAYER
200 INJECTION MOLDED PRODUCT

1. A composition comprising: a magnetic powder and a thermoplastic resin,
wherein at least a part of the magnetic powder has a coating layer.

2. The composition according to claim 1, wherein the coating layer comprises one or more selected from a glass, a silicone resin, and a coupling agent.

3. The composition according to claim 1, wherein the coating layer comprises one or more selected from a glass and a silicone resin.

4. The composition according to claim 1, wherein the coating layer comprises a coupling agent.

5. The composition according to claim 1, wherein the coating layer comprises a first layer comprising one or more selected from a glass and a silicone resin, and a second layer comprising a coupling agent.

6. The composition according to claim 1, wherein the magnetic powder comprises an Fe-based nanocrystalline alloy.

7. The composition according to claim 1, wherein the magnetic powder comprises an Fe—Si alloy.

8. The composition according to claim 1, wherein the magnetic powder comprises a first magnetic powder having a median diameter of 1 to 50 μm and a second magnetic powder having a median diameter of 10 to 300 μm, and the median diameter of the second magnetic powder is larger than the median diameter of the first magnetic powder.

9. The composition according to claim 8, wherein the first magnetic powder is an Fe-based nanocrystalline alloy, and the second magnetic powder is an Fe—Si alloy.

10. The composition according to claim 8, having a mass ratio between the first magnetic powder and the second magnetic powder of 95:5 to 50:50.

11. The composition according to claim 2, wherein the glass comprises a phosphate glass.

12. The composition according to claim 1, having a melt flow rate of 80 g/10 minutes or more at 330° C.

13. The composition according to claim 1, for injection molding.

14. An injection molded product of the composition according to any one of claim 1.

15. The injection molded product according to claim 14, having a core loss of 350 kW/m³ or less measured under conditions at a frequency of 20 kHz and an applied magnetic flux density of 100 mT.

16. The injection molded product according to claim 14, having a core loss of 2800 kW/m³ or less measured under conditions at a frequency of 100 kHz and an applied magnetic flux density of 100 mT.

17. The injection molded product according to claim 14, having a magnetic permeability retention rate of 83% or more at a frequency of 100 kHz and a magnetic field strength of 8 kA/m.

18. The injection molded product according to claim 14, having a radial crushing strength of 40 MPa or more.

19. The injection molded product according to claim 14, having a resistance value of 1×10¹³Ω or more.
